(19) United States
(12) Patent Application Publication
(10) Pub. No.: US 2022/0270478 A1
(43) Pub. Date: Aug. 25, 2022

(54) System and Method for Deployment of a Hyperloop Commuting Network

(71) Applicant: Hyperloop Technologies, Inc., Los Angeles, CA (US)

(72) Inventor: Dapeng Zhang, Covina, CA (US)

(73) Assignee: Hyperloop Technologies, Inc., Los Angeles, CA (US)

(21) Appl. No.: 17/584,894

(22) Filed: Jan. 26, 2022

Related U.S. Application Data
(60) Provisional application No. 63/152,350, filed on Feb. 23, 2021.

(51) Int. Cl. G08G 1/01

(52) U.S. Cl. CPC G08G 1/0145; G08G 1/0141; G08G 1/0133

(57) ABSTRACT

A solution is disclosed comprising a system and method for deploying a transportation network having a hyperloop network. The solution may be configured to perform processing on models related to existing land use, portal infrastructure, hyperstructure, and route usage in order to generate a deployment cost model. The deployment cost model may have a capital expenditure component and an operating costs component. The solution may generate analytics based on the processed and generated models for presentation via a user interface that is accessible by a human operator. Further, the human operator may interact with the user interface to modify the models and view resulting analytics.

### CROSS REFERENCE AND PRIORITY TO RELATED APPLICATIONS

This application claims the benefit of priority to: U.S. Provisional No. 63/152,350 entitled “SYSTEM AND METHOD FOR A HYPERLOOP COMMUTING NETWORK,” filed on Feb. 23, 2021.

All the aforementioned applications are hereby incorporated by reference in their entirety.

### BACKGROUND

Hyperloop is a passenger and cargo transportation system relying on a sealed tube and a bogie attached to a pod. The sealed tube may have a substantially lower air pressure than the external environment. For example, a hyperloop tube may have an internal air pressure at approximately one millibar (100 Pa). As such, the bogie and the attached pod may travel with reduced air resistance, thus increasing energy efficiency as well as performance. Further, the acceleration and the velocity of the bogie may be substantially higher than a comparable bogie operating within a gas environment with a higher pressure (including at standard air pressure of one atmosphere).

A hyperloop bogie may rely on many types of propulsion (e.g., wheeled bogies). Some hyperloop systems rely on magnetic levitation (sometimes referred to as “maglev”). The advantage of using maglev is a further reduction in friction viz. the resistance between a traditional wheel and a traditional track is eliminated by using a maglev-based bogie. Hyperloop is in the early stages of development and commercialization. However, the projected velocity of the bogie may exceed 700 mph (1,127 km/h) in commercialized implementations.

The deployment of hyperloop will occur in the midst of many legacy modes of transportation viz. train, automobile, aircraft, watercraft, bicycle, etc. In some implementations, hyperloop will need to utilize existing rights-of-way. For example, deployment of a hyperloop system in a densely populated city will require coordination between various modes of existing transportation (e.g., subway, train, automobile, bus, etc.). In other implementations, hyperloop may be deployed in a new operating environment where other modes of transportation are limited. For example, in a new city, hyperloop would be one among a few modes of transportation. Thus, the new city may require less coordination with existing modes of transportation.

Deployment of hyperloop networks is a non-trivial undertaking given the myriad of configurations available in light of existing modes of transportation, land use, demographics, construction costs, operating costs, etc. Further, the deployment of a hyperloop network will affect the very constraints which initially influenced an initial deployment. For example, with freeway deployment, people frequently move to places where freeway access is available and not overburdened. Thus, a newly available mode of transportation may affect land use itself as people migrate based on availability and reliability of transportation (which may be hyperloop-based).

What is needed is a system and method for deployment of a hyperloop network.

### SUMMARY

A solution comprising a system and method is disclosed for deploying a transportation network having a hyperloop network. The solution may perform, at a processor, analytics on existing land use within a land area to form an existing land use model. The solution may further generate, at the processor, a portal infrastructure model, wherein the portal infrastructure model relates to a real-world layout of a plurality of hyperloop portals. The solution may further generate, at the processor, a hyperstructure model, wherein the hyperstructure model relates to a real-world layout of a plurality of routes, and the plurality of routes are configured for hyperloop transportation between the plurality of portals. The solution may further generate, at the processor, a route usage model, wherein the route usage model is based on the hyperstructure model and the portal infrastructure model. The solution may further generate, at the processor, a deployment cost model, wherein the deployment cost model has a capital expenditure component and an operating costs component, wherein the capital expenditure component relates to the portal infrastructure model and the hyperstructure model, and wherein the operating costs component relates to the route usage model. The solution may further generate, at the processor, a first plurality of analytics, wherein the first plurality of analytics is based on the deployment cost model. The solution may present, at a user interface, the first plurality of analytics.

The solution may further generate at the processor, a future land use model, wherein the future land use model is based on the existing land use model. The solution may further generate, at the processor, a future deployment cost model, wherein the future deployment cost model is based on the deployment cost model. The solution may further generate, at the processor, a second plurality of analytics, wherein the second plurality of analytics is based on the future deployment cost model. The solution may present, at the user interface, the second plurality of analytics.

The solution may further generate, at the processor, an existing modalities of travel model, wherein the existing modalities of travel model is based on non-hyperloop modalities of travel. The solution may generate, at the processor, a third plurality of analytics, wherein the third plurality of analytics is based on the existing modalities of travel model. The solution may further present, at the user interface, the third plurality of analytics.

The solution may further generate, at the processor, a demographics model, wherein the demographics model is based on a demographic. The solution may further generate, at the processor, a fourth plurality of analytics, wherein the fourth plurality of analytics is based on the demographics model. The solution may further present, at the user interface, the fourth plurality of analytics.

The solution may combine, at the processor, the existing land use model, the portal infrastructure model, the hyperstructure model, the route usage model, the deployment cost model to form a transportation network model, wherein the transportation network model is related to the transportation network. The solution may further optimize, at the processor, the transportation network model to form an optimized transportation network model.

The solution may present a transportation network on a user interface by generating, at a processor, a transportation network model, wherein the transportation network model is a logical representation of the transportation network. The transportation network may have a hyperloop component. The solution may further generate, at the processor, a land use model, wherein the land use model is based on a real-world land area and the transportation network model. The solution may generate, at the processor, a first plurality of analytics, wherein the first plurality of analytics is based on the land use model. The solution may present, at the user interface, the first plurality of analytics.

The solution may further generate, at the processor, a future transportation network model, wherein the future transportation network model is based on the transportation network model. The solution may further generate, at the processor, a prediction of a future land use model, wherein the prediction is based on the land use model and the future transportation network model. The solution may further generate, at the processor, a second plurality of analytics, wherein the second plurality of analytics is based on the future land use model. The solution may further present, at the user interface, the second plurality of analytics.

The solution may further receive, at the user interface, input modifying the transportation network model and generate, at the processor, a modified transportation network model based on the received input. The solution may further generate, at the processor, a third plurality of analytics, wherein the third plurality of analytics is based on the modified transportation network model. The solution may further present, at the user interface, the third plurality of analytics.

The solution may further generate, at the processor, an existing modalities of travel model based on modes of non-hyperloop transportation and generate, at the processor, a fourth plurality of analytics, wherein the fourth plurality of analytics is based on the existing modalities of travel model. The solution may further present, at the user interface, the fourth plurality of analytics.

### BRIEF DESCRIPTION OF DRAWINGS

The accompanying drawings, which are incorporated herein and constitute part of this specification, illustrate exemplary aspects of the claims, and together with the general description given above and the detailed description given below, serve to explain the features of the claims.

FIG. 1A is a block diagram illustrating a transportation network.

FIG. 1B is a block diagram illustrating a transportation network.

FIG. 1C is a block diagram illustrating a transportation network.

FIG. 1D is a block diagram illustrating a transportation network.

FIG. 2 is a block diagram of an operating constraints module.

FIG. 3 is a flowchart of a process for performing a hyperloop network deployment.

FIG. 4A is block diagram of a user interface configured to deploy a hyperloop portal.

FIG. 4B is block diagram of a user interface configured to predict changes in land value.

FIG. 4C is block diagram of a user interface configured to predict alternative mode of travel usage.

FIG. 5 is a block diagram illustrating an example server suitable for use with the various aspects described herein.

### DETAILED DESCRIPTION

Various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Hyperloop is an evolving technology that can address many existing problems in the transportation and logistics industries. One issue facing the transportation and logistics industries is land use. Transportation on land simply requires land. Whether the mode is automobile, train, bicycle, light rail, standard rail, airport, seaport—all require some access to land. Likewise, hyperloop requires land for deployment because both the hyperstructure and portals create a footprint on existing land. Given that land is a finite resource and transportation requirements are ever-expanding, the problem of unavailable land faces all transportation modalities. In congested urban areas, land may be unavailable due to use by existing modes of transportation; for example, a railway may have a one-hundred-year lease for a particular city, thus excluding hyperloop from deployment within the leased area.

The disclosed solution provides a system and method for deploying a hyperloop network within a congested area of land. For example, the disclosed solution may be configured to deploy a hyperloop network alongside existing freeways because the freeway already abuts a natural, protected habitat. Stated differently, the disclosed solution may be configured to deploy a hyperloop network when existing land-use constraints limit the possible configurations (or deployments) of the hyperloop network.

Even if land were available, the area may not be economically viable due to high capital expenditure costs that may not be recouped during operation. If an operator is willing to invest large amounts of capital, there is naturally an expectation of a return on investment, often in the form of ongoing revenue. Without adequate modelling and projections, an operator may not have the confidence in the outcome of the hyperloop network deployment. One factor that affects future revenue is the replacement of existing modes of transportation by hyperloop. For example, the operator may be relying on weekday office workers to pay fares in order to commute to a large city. However, without proper modelling, the operator has little confidence that the workers will replace automobile transportation with hyperloop transportation. As a result, the operator will not undertake the project.

The disclosed solution provides for modelling of potential customers who may be willing to replace existing modes of transportation with hyperloop. In some circumstances, only a partial replacement may occur, i.e., the commuter may use both automobile and hyperloop for travel. The disclosed solution provides for determining such multimodal transportation use cases such that the share of hyperloop usage may be determined for situations where an outright replacement of an existing mode is not realized.

Transportation itself may affect the land use, thus creating new challenges for both hyperloop networks and any legacy transportation networks. One phenomenon with deployment of hyperloop transportation networks is a follow-on growth pattern. A hyperloop route may be built to connect an existing area of land that is devoid of buildings, commerce, infrastructure, and people. However, as people and businesses realize the new hyperloop route serves an underutilized tract of land, businesses and residences migrate to such underutilized land. Such a phenomenon runs counter to what one might think about the relationship between transportation and growth in land use, i.e., some might believe that transportation networks are deployed in response to growth, not vice versa. Without adequate modelling, the follow-on growth pattern may not be known prior to large capital expenditure.

The disclosed solution provides for modelling of such follow-on growth patterns. In some circumstances, the follow-on growth may be desirable. For example, a municipality may desire to increase the number of taxpayers residing in an area. In other circumstances, follow-on growth may be less desirable. For example, a school system in a particular area may be overcrowded, and the municipality may be trying to slow growth until the school system is prepared to serve additional students. Thus, such follow-on growth may be predicted, modelled, and analyzed via the disclosed solution.

Transportation infrastructure has an associated operating cost. However, modelling and predicting operating costs is difficult. For example, if a hyperloop network is deployed to an underutilized area of land, the initial operating costs may be high since the pods are not filled to capacity (as few people live in the underutilized area of land). However, the use of the land may increase considerably after people and businesses begin to realize that the areas served by hyperloop are attractive for economic and even quality-of-life reasons. For example, an empty area of land with a newly built hyperloop portal may experience a few years of underutilization before an explosion of growth in the area.

The disclosed solution provides comprehensive modelling, prediction, and analysis of ongoing operating costs. As described above, the use of a hyperloop network is complex given the many factors that influence the network (e.g., land use, commuter demographics, etc.). The disclosed solution is configured to accept as input the many relevant factors and provide models, predictions, and analytics to stakeholders in order to determine the economic viability of a hyperloop network.

Increasing the use and degree of use has many benefits. One benefit is an increase in land value. Increasing land value is not only beneficial for those who purchased land but also for local municipalities which derive tax revenue from the use of the land. Further, the advancement of more commercial and industrial uses may increase the economic viability of an area, thus improving both the quality and desirability of the area. For example, new factories near a hyperloop portal may encourage workers from longer distances to be able to reach the factories near the hyperloop portal in order to earn higher wages.

The disclosed solution provides for predictive modelling of such increases in land value caused by the deployment of a hyperloop network. Such predictive modelling enables operators (and stakeholders) to determine the economic viability of a hyperloop project prior to undertaking the large capital expenditure required to deploy the project.

Once a hyperloop network is in operation, the cost of fares and the operation of routes requires constant analysis and modelling. For instance, if fares are too high, ridership may decrease. If fares are too low, the operator may not be able to profit. However, pricing is not a static determination but rather an ongoing determination. Without adequate tools, the pricing and availability of routes will be based more on reactions to market forces rather than a strategy based on predictive models which are informed by data.

The disclosed solution provides ongoing modelling, prediction, and analysis of an operating hyperloop network. Such ongoing modelling, prediction, and analysis provides for increased profitability to operators as well as customer satisfaction. Further, stakeholders such as municipalities may be better informed about decisions facing the hyperloop network. For example, a municipality may better understand whether to expand a hyperloop network based on customer demand.

In sum, deployment of a hyperloop network is often a high-capital endeavor and requires precise modelling to be profitable. Land may need to be purchased. Hyperstructure may need to be built. Permitting by local authorities may be required. Safety standards may need to be established and enforced. To add further challenges, the deployment of the hyperloop network is generally indelible as the cost to rearrange or even augment a hyperloop network is non-trivial. Further, the demolition of hyperstructure is exceedingly expensive.

Therefore, the deployment of hyperloop networks has challenges but also many benefits that may be realized by businesses, municipalities, residents, and the environment. The disclosed solution addresses the aforementioned problems by providing a system and a method for the deployment of a hyperloop network such that many of the problems described above are mitigated or outright avoided via modelling, prediction, and analysis.

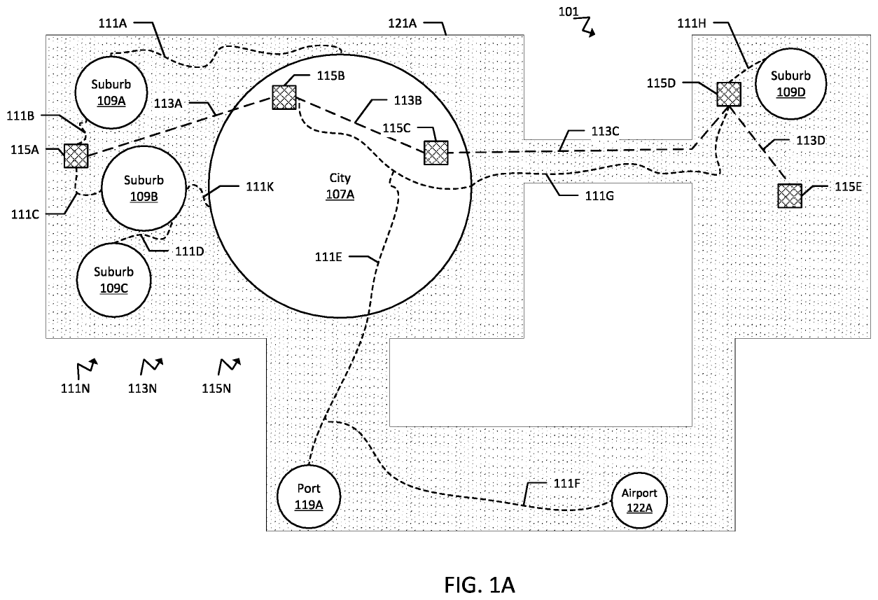

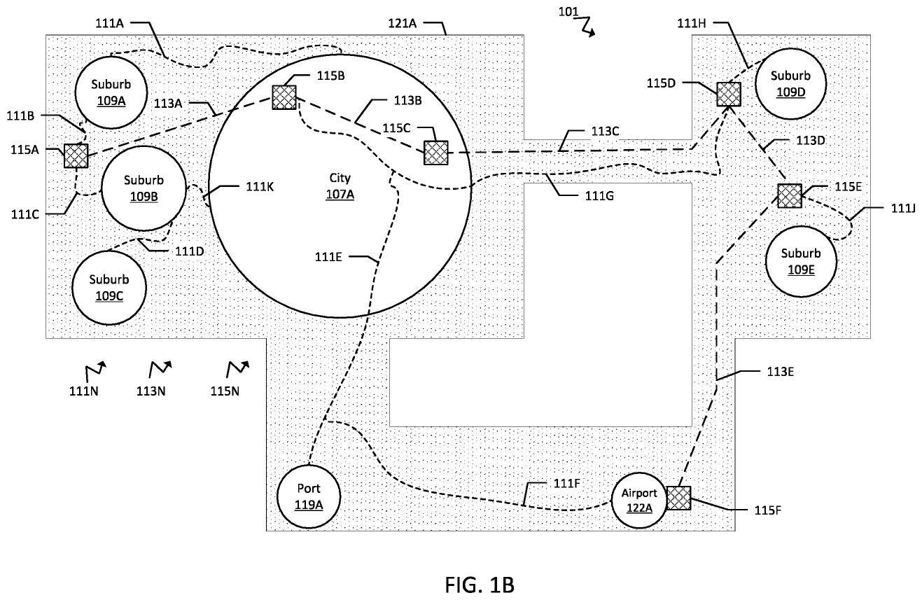

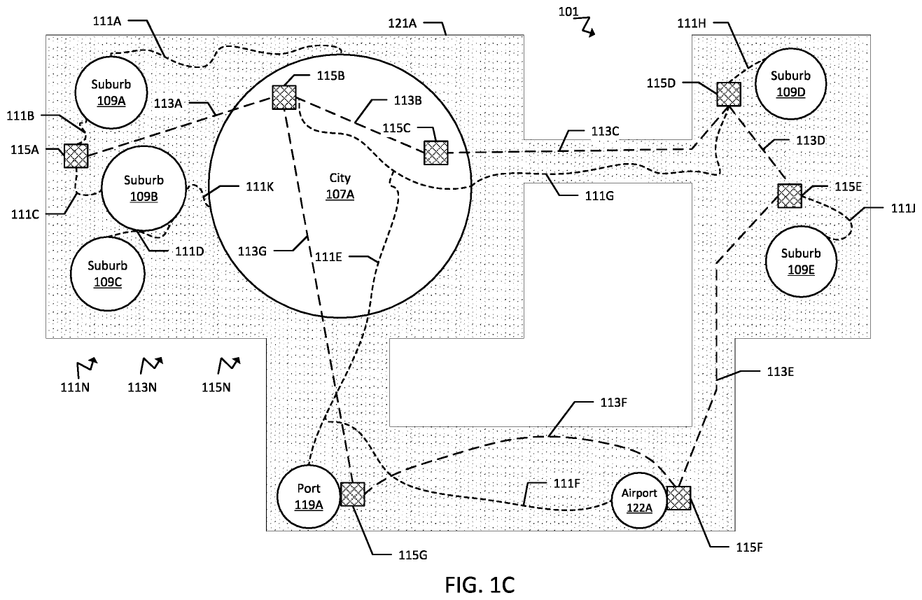

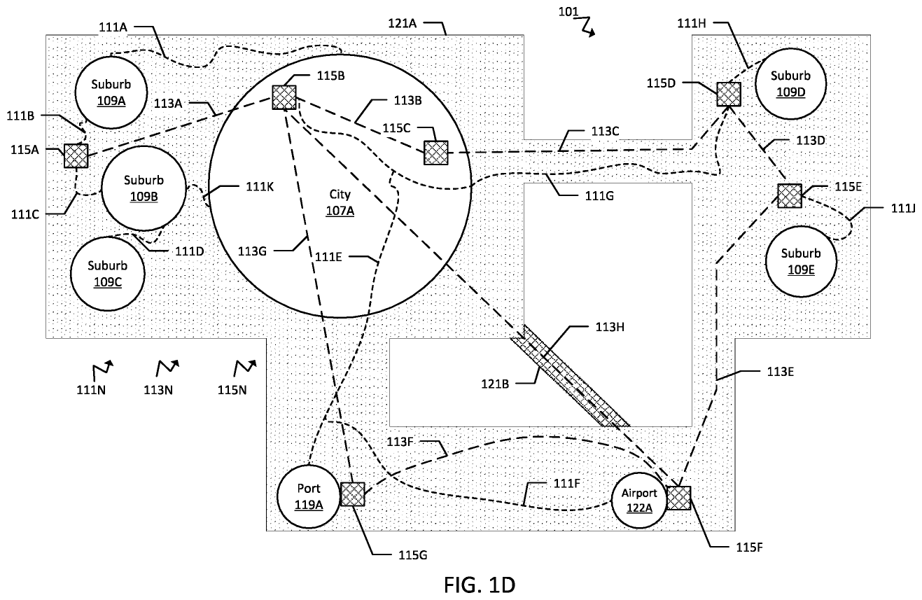

FIG. 1A is a block diagram illustrating a transportation network 101. The transportation network 101 may be deployed within a land area 121A. The land area 121A may be defined by a number of parameters. For instance, the land area 121A may be defined by land that is owned, purchasable, and/or liquid. In some areas of the world, land is unavailable for use as the land may be designated as a nature preserve, in which case no transportation mode may be deployed therein. In another situation, the land may be unavailable for purchase due to competing economic uses (e.g., an industrial company is using the land for extraction of mineral resources). As such, the land outside the shaded land area 121A may be considered unusable by the transportation network 101.

A city 107A may be disposed on the land area 121A. The city 107A may be considered a large city (e.g., London, Mumbai, etc.). As such, the city 107A may be connected by a myriad of transportation modes including rail, automobile, ship, etc. Many cities are surrounded by smaller municipalities or suburbs. For illustrative purposes, the cities and suburbs referred to herein should generally be considered relative and not exact. For instance, a suburb in China may be considered a large city in Eastern Europe or Australia. One of skill in the art will appreciate that some metropolitan areas are large and some are small.

The land area 121A may have a first suburb 109A, a second suburb 109B, a third suburb 109C, and a fourth suburb 109D. The suburbs 109A, 109B, 109C, 109D may be generally considered metropolitan areas that are smaller in both size and population than a similarly situated city (e.g., the city 107A). In one aspect, the suburbs 109A, 109B, 109C, 109D may generally be considered single-use areas of land, i.e., a particular suburb may be substantially residential while another suburb may be substantially commercial. On the other hand, the city 107A may be of mixed use where residential, commercial, and industrial use all coexist.

The transportation network 101 may have a first portal 115A, a second portal 115B, a third portal 115C, a fourth portal 115D, and a fifth portal 115E. The portals 115A, 115B, 115C, 115D, 115E may form a plurality of portals 115N. The plurality of portals 115N are locations where a hyperloop pod may perform a number of actions, including but not limited to: load passengers, unload passengers, load cargo, unload cargo, perform maintenance, remove pods from service, add pods to service, change operating personnel, etc. One of skill in the art will appreciate that the plurality of portals 115N may have slightly different functionality but perform many of the same functions. For example, a seaport coupled to a portal may have many of the characteristics of a seaport and a train station, plus the unique aspects of hyperloop (e.g., emissionless vehicles, moving platforms, etc.).

The transportation network 101 may have a port 119A. The port 119A may be generally operable to dock ships at births, in one aspect. For example, cargo is largely transported by sea via container-based cargo ships. When cargo ships dock, the cargo containers are unloaded onto dry land. Traditionally, a semi-truck arrives with a trailer to receive and deliver cargo containers.

The transportation network may have an airport 122A. The airport 122A is generally operable to enable air-based modes of transportation (e.g., airplane, helicopter, etc.). In the instant example, the airport 122A serves the city 107A, the port 119A, and the suburbs 109A, 109B, 109C, 109D.

The portal 115A may be connected to the portal 115B via a route 113A. The route 113A is generally operable to provide an environment for the hyperloop pod in which to travel. The route 113A may be comprised of an elevated series of pylons that support an above-ground tube, i.e., a hyperstructure. Within the tube, a near-vacuum pressure environment provides low air resistance thus increasing velocity, energy efficiency, etc. In another embodiment, the route 113A may be subterranean and contained within a similar tube as the above-ground example above. While the route 113A, and many other similar illustrations, are denoted with substantially straight lines, one of skill in the art will appreciate that natural curves and turns would be present for a hyperstructure in a commercial deployment.

A route 113B connects the portal 115B to the portal 113C. A route 113C may connect the portal 115C to the portal 115D. A route 113D may connect a portal 115D to a portal 115E. The routes 113A, 113B, 113C, 113D may form a plurality of routes 113N. One of skill in the art will appreciate that the plurality of portals 115N and the plurality of routes 113N are used for illustrative purposes and may have multiple instances within a particular location. For instance, the portal 115A may be comprised of three smaller portals (not shown) that form a discrete transportation network. The plurality of routes 113N may be comprised of hyperstructure that may be subterranean, underwater, on-ground, above-ground, or combination thereof.

A plurality of roads 111N may be comprised of a first road 111A, a second road 111B, a third road 111C, a fourth road 111D, a fifth road 111E, a sixth road 111F, a seventh road 111G, and an eighth road 111K. The plurality of roads 111N may support any existing mode of ground transportation, including, but not limited to, automobile, train, trolley, subway, aircraft, ferry, bus, carpool, ridesharing, etc. In modernized cities, high-speed rail may be considered a user of the plurality of roads 111N. One of skill in the art will appreciate the plurality of roads 111N is utilized for illustrative purposes and may, in one aspect, simply be the means by which an existing, non-hyperloop vehicle travels.

The road 111A may connect the suburb 109A to the city 107A. The road 111B may connect the portal 115A to the suburb 109A. The road 111C may connect the portal 115A to the suburb 109B. The road 111D may connect the suburb 109B to the suburb 109C. The road 111K may connect the city 107A to the suburb 109B. The road 111E may connect the route 111G to the port 119A. The road 111F may connect the airport 122A to the route 111E.

In one aspect, the suburbs 109A, 109B, 109C, 109D are connected to the city 107A. In many metropolitan areas, people reside in suburbs and commute to larger city centers. The cities generally have more commercial and industrial opportunities for workers. Stated differently, the land use in the suburbs 109A, 109B, 109C, 109D is different than that of the city 107A because the suburbs 109A, 109B, 109C, 109D are primarily residential and the city 107A is mixed use.

In one aspect, the hyperloop portal 115A is an example of how the suburbs 109A, 109B may utilize hyperloop. For instance, a worker living in the suburb 109A may take the road 111B to the portal 115A where the worker may park the car in a garage. Then, the worker may use the hyperloop route 113A to arrive at the portal 115B within the city 107A. The worker could then walk to a nearby place of work (e.g., an office complex).

In another example, the hyperloop portal 115E is positioned at the right side of the land area 121A. One of skill in the art will appreciate that most of the suburbs 109A, 109B, 109C, 109D are connected by the plurality of roads 111N. However, the introduction of the hyperloop portal 115E in the land area 121A provides an opportunity for land use at and around the hyperloop portal 115E.

The plurality of roads 111N and the plurality of routes 113N form a mesh by redundantly connecting many points within the transportation network 101 (e.g., the suburb 109B has several entries and exits). However, the portal 115E is only connected by the hyperloop route 113D. Such a deployment is an example of how a hyperloop portal may encourage growth in an underutilized area of land. A new, efficient mode of transportation like hyperloop may encourage people in the city 107A to purchase land in the vicinity of the portal 115E in order to avoid city congestion, noise, pollution, inadequate schools, crime, etc.

FIG. 1B is a block diagram illustrating the transportation network 101. The instant figure illustrates how the introduction of the portal 115E encouraged growth so much so that a suburb 109E was founded. The suburb 109E may be connected to a road 111J that leads to the portal 115E. One of skill in the art will appreciate how the use of roads to and from the suburb 109E is minimal due to (1) the proximity to the portal 115E and (2) the suburb 109E being built with the portal 115E as a primary mode of transportation for the area. Therefore, the inhabitants of the suburb 109E largely rely on hyperloop for transportation needs when travelling beyond the nearby area of the suburb 109E.

A hyperloop portal 115F is positioned substantially near to the airport 122A to illustrate that in some implementations, a portal may be tightly coupled to a nearby location. In the instant example, the airport 122A may unload passengers (near the portal 115F) directly into hyperloop pods travelling toward the city 107A.

The hyperloop portal 115F is connected to the hyperloop portal 115E via a route 113E. The airport 122A is connected to the city 107A by the roads 115E, 115F as well as the routes 113C, 113D, 113E. In this example, hyperloop and existing automobile modalities co-exist to form part of the transportation network 101.

FIG. 1C is a block diagram illustrating the transportation network 101. A portal 115G is shown as being tightly coupled to the port 119A. In one aspect, cargo ships docking at the port 119A may unload cargo containers bound for the city 107A. Prior to the introduction of the portal 115G, cargo had to be carried via the road 111E using traditional semi-trucks.

A route 113G may now connect the portal 115G to the portal 115B. The route 113G may be specially configured to carry cargo-laden pods, that are destined for the city 107A, in one aspect. In another aspect, the pods travelling along the route 113G may be a mix of passenger-configured and cargo-configured pods. A route 113F may connect the portal 115G to the portal 115F. The route 113F may be utilized for a combination of passenger and cargo traffic. For instance, passengers may arrive at the airport 122A, enter the portal 115F, travel via the route 113F to the portal 115G, and finally travel along the route 113G to arrive at the portal 115B. In another example, cargo may be offloaded from airplane at the airport 122A and then be transported to the port 119A via the route 113F. Likewise, the cargo may be transported between the port 119A and the city 107A (or to any other destination).

FIG. 1D is a block diagram illustrating the transportation network 101. The instant figure illustrates a land area 121B that has been acquired to connect two separate sections of the land area 121A. The land area 121B is generally disposed such that a hyperloop route 113H may directly service the portal 115F (near the airport 122A) and the portal 115B (within the city 107A). The instant example depicts how the growth of hyperloop enables more land use while not creating additional burdens on existing modes of transportation. Further, deployment of hyperloop reduces emissions caused by fossil-fuel-burning engines.

One of skill in the art will appreciate the progression of land use between the FIG. 1A and the FIG. 1D. The portal 115B has increased the connections via both routes and roads to the other points in the transportation network 101. As such, the area of the city 107A that is adjacent to the portal 115B may experience an increase in real estate value (thus increasing tax revenue).

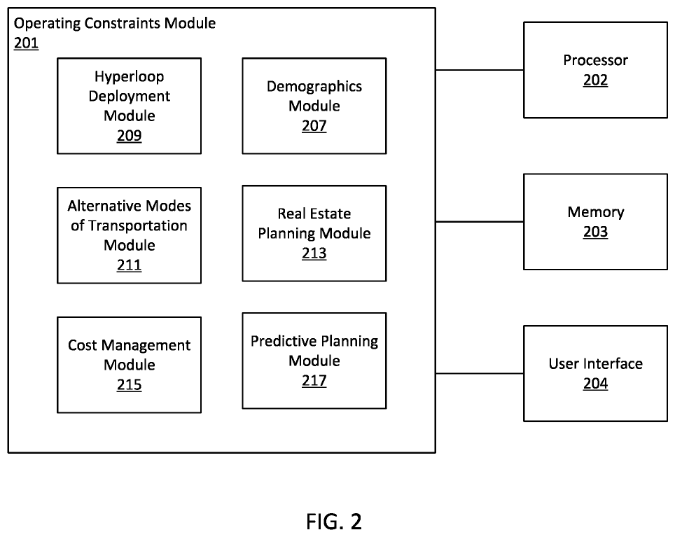

FIG. 2 is a block diagram of an operating constraints module 201. The operating constraints module 201 may be software-implemented, hardware-implemented, or a combination thereof. For example, the operating constraints module 201 may run on a standalone server, a cloud-based server, a distributed computation network, etc. In another aspect, the operating constraints module 201 may be implemented in hardware. For example, the operating constraints module 201 may be implemented using field-programmable gate arrays, application-specific integrated circuit, etc.

The operating constraints module 201 is generally configured to perform the processing, modelling, analysis, prediction, and decision-support related to the deployment of the transportation network 101. The operating constraints module 201 may generate a model of the transportation network 101 in order for stakeholders to understand the configuration of the transportation network 101. For example, the operating constraints module 201 may be utilized by an operator that is planning a deployment of a hyperloop network (either in whole or in part). For example, a city-planning committee may work in conjunction with a hyperloop operator by using the operating constraints module 201 as part of the process of determining the effect of hyperloop deployment to existing modes of transportation, real-estate value, economic development, efficient use of land, protection of natural resources, etc.

The operating constraints module 201 may generate a predictive model that may be based on an existing model of the transportation network 101. Such a predictive model enables stakeholders (e.g., municipalities) to understand how various factors may affect the transportation network 101. For example, follow-on growth is common when new infrastructure (such as hyperloop) is deployed. Predicting the nature of the follow-on growth is critical to stakeholders because hyperloop has a high capital expenditure cost that may require follow-on growth to achieve economic viability.

The operating constraints module 201 may have a hyperloop deployment module 209, a demographics module 207, an alternative modes of transportation module 211, a real estate planning module 213, a cost management module 215, and a predictive planning module 217. The operating constraints module 201 may be in communication with a processor 202, a memory 203, and a user interface 204.

The processor 202 may be a shared processor which is utilized by other systems, modules, etc. within the disclosed solution. For example, the processor 202 may be configured as a general-purpose processor (e.g., x86, ARM, etc.) that is configured to manage operations from many disparate systems, including the operating constraints module 201. In another aspect, the processor 202 may be an abstraction because any of the modules, systems, or components disclosed herein may have a local processor (or controller) that handles aspects of the operating constraints module 201 (e.g., ASICs, FPGAs, etc.).

The memory 203 is generally operable to store and retrieve information. The memory 203 may be comprised of volatile memory, non-volatile memory, or a combination thereof. The memory 203 may be closely coupled to the processor 202, in one aspect. For example, the memory 203 may be a cache that is co-located with the processor 202. As with the processor 202, the memory 203 may, in one aspect, be an abstraction wherein the modules, systems, and components each have a memory that acts in concert across the operating constraints module 201.

The user interface 204 is generally configured to enable a human operator to view, manipulate, store, print, transfer, and/or receive data and information related to inputs and outputs of the operating constraints module 201. For example, the user interface 204 may be a desktop computer configured to use software embodying the operating constraints module 201. Further, the software may be a web-based, interactive application that provides an operator with a heat map of areas (in the land area 121A) that have higher operating costs relative to other areas. For instance, the port 119A may have higher operating costs and thus be shown to a human operator who is interacting with the user interface 204 (which may be keyboard, mouse, and display). One of skill in the art will appreciate that the user interface 204 may be a laptop, a desktop, a tablet, a smartphone, a web-based application, a desktop application, a mobile application, or a combination thereof.

The hyperloop deployment module 209 may be generally configured to perform the analysis to optimize the physical and logical layout of the transportation network 101. In one aspect, the hyperloop deployment module 209 gathers data related to alternative modes of transportation within the transportation network 101. For example, the alternative modes of transportation module 211 may be utilized to analyze the existing modes of transportation (e.g., automobile, bus, etc.). Further, the hyperloop deployment module 209 may build a model of the transportation network 101. Optionally, the hyperloop deployment module 209 may augment the model with potential configurations of the transportation network 101.

The hyperloop deployment module 209 may utilize the logic in the real estate planning module 213 to determine the availability and cost of land, in one aspect. For example, the hyperloop deployment module 209 may determine that the land area 121A may be augmented to accommodate a hyperloop route. For example, the land area 121A has a portion that separates the city 107A from the airport 122A. The separation creates inefficient routes (e.g., the routes 113F, 113G) between the airport 122A and the city 107A. Augmenting the land area 121A may be determined by the predictive planning module 217 in coordination with the hyperloop deployment module 209 such that the land area 121B may be acquired in order to deploy the route 113H.

When the configuration of the transportation network 101 changes due to land acquisition, the hyperloop deployment module 209 may determine an updated configuration of the transportation network 101 that includes the land area 121B as connected to the land area 121A. The hyperloop deployment module 209 may determine the new layout of the transportation network 101, as augmented by the land area 121B, such that the route 113H may be deployed. The configuration may be presented to a human operator as a model, which may be further processed and modified based on human input.

The demographics module 207 is generally configured to perform analysis related to the demographics of the users of the transportation network 101. Demographics generally relate to statistics of populations (or groups within a population). With respect to hyperloop, demographics of interest are related to the ability of users to utilize the transportation network 101. For example, if commuters are low-paid factory workers, then fares may need to be priced lower to be affordable on the incomes of said workers. Likewise, the capacity of the pods may need to be increased in order to create a volume of lower fares that meets profitability goals.

The demographics module 207 may utilize census data to determine the demographics of an area of land. For example, the census data may be used to derive the average household income. Further, such data may inform the fares related to travel on the transportation network 101. In one aspect, the demographics module 207 may be utilized to analyze the fares of alternative modes of transportation. Such analysis may provide a reliable indication of what users are already paying and thus inform what users may be willing to pay for hyperloop fares. For example, the costs of tolls on bridges may be analyzed by the demographics module 207 to determine the effect of pricing changes in both hyperloop and alternative modes of transportation.

In addition, the demographics module 207 is generally configured to perform analysis and computation related to the users of the transportation network 101 in order to increase fares. For instance, if the inhabitants of the suburb 109A are economically advantaged, then the hyperloop use might be higher if fares are increased in order to provide more first-class capacity. Further, the stakeholders may be better informed about deploying additional routes to service affluent areas while not sacrificing profitability due to overhead related to first-class travel.

The demographics module 207 is generally configured to provide data to the predictive planning module 217. In one aspect, the demographics module 207 may be utilized to determine the effects on demographics in an area. For example, the portal 115D may bring more wealth appreciation to middle class families living in the suburb 109D because nearby home values increase. One of skill in the art will appreciate that the demographics module 207 may communicate with the real estate planning module 213 to determine specific values of land and any associated increases or decreases in value. Such value-related information may be of particular interest to operators of the transportation network 101 because such increases in value may provide support for the economic viability of the transportation network 101. Similarly, such land value increases provide more stability for the community, which may be governed by municipalities that also seek to increase local tax revenue. Such positive effects may be determined by the demographics module 207, in one aspect.

The alternative modes of transportation module 211 may be generally configured to analyze and coordinate the hyperloop deployment within the transportation network 101, as performed by the hyperloop deployment module 209. Alternative modes of transportation are generally non-hyperloop-based modes such as, but not limited to: automobile, train, trolley, subway, aircraft, ferry, bus, carpool, ridesharing, etc.

The alternative modes of transportation module 211 may contain data relating to each of the alternative modes such that the association with hyperloop may be determined and analyzed by the predictive planning module 217. For example, the alternative modes of transportation module 211 may determine that commuters from suburb 109A generally commute via ridesharing on weekdays to the city 107A. However, the alternative modes of transportation module 211 may also determine that residents in suburb 109A generally utilize individual cars to visit various locations outside of the city 107A.

Given that hyperloop is a new mode of transportation, some existing modes of transportation will inevitably be replaced. As such, the predictive planning module 217 may be in communication with the alternative modes of transportation module 211 such that modelling and predictions may inform operators as to how existing modes may be replaced. For example, the alternative modes of transportation module 211 may provide data relating to how many automobiles are planned to be in operation two years after the introduction of hyperloop along the 113C. The predictive planning module 217 may receive such data in order to provide information to stakeholders as to how to reduce support for automobiles. For example, municipalities may opt to reduce freeway expansion on the road 111G. One of skill in the art will appreciate how the predictive nature of the operating constraints module 201 provides stakeholders with not only information relevant today but also to the future of the transportation network 101.

The plurality of roads 111N may be analyzed (by the alternative modes of transportation module 211) in an existing state or in a future state. For example, the alternative modes of transportation module 211 may utilize information related to changes in the plurality of roads 111N that may affect demand within the plurality of routes 113N. Such demand changes may affect decisions related to the operation of the transportation network 101, including but not limited to: fare pricing, energy demands, pod availability, efficiency of trip, weather, personnel support, etc.

In another example, the alternative modes of transportation module 211 may be updated with information related to a new, alternative mode of transportation. For example, as shown in FIG. 1D, the addition of the road 111J connecting the suburb 109D to the portal 115E may affect planning for hyperloop demand near the portal 115E. As shown, the portal 115E is the primary mode of transportation, of the suburb 109E, to other locations in the transportation network 101. However, after the introduction of a new, alternative mode of transportation, the operating constraints module 201 may then update existing hyperloop support in the transportation network 101 such that optimized hyperloop service is provided to the suburb 109D.

The real estate planning module 213 may be generally configured to determine land use and land values. For example, the real estate planning module 213 may determine the land use within the land areas 121A, 121B. As a further example, the addition of the suburb 109E creates a new schema of the real estate pricing within the land area 121A. Deployment of hyperloop routes (e.g., the plurality of routes 113N) may be determined by the hyperloop deployment module 209, as operating in coordination with the real estate planning module 213, to determine an optimized cost model of real estate acquisition, disposal, taxation, use, etc. Stated differently, the price of land may increase due to the introduction of hyperloop; as such, the real estate planning module 213 not only manages such price fluctuations but also informs the hyperloop deployment module 209 as to how future hyperloop expansion (or even contraction) will be affected by updated real estate pricing.

The cost management module 215 may be generally configured to determine the costs of deploying, managing, and expanding aspects of hyperloop within the transportation network 101. For example, the cost management module 215 may determine the costs of deploying a hyperloop route in terms of both capital expenditure as well as operating costs. One difficult problem in the hyperloop industry is providing clear modelling for operators and municipalities as to the type and magnitude of costs. In other words, a city cannot simply allocate large amounts of capital to deploy a hyperloop network that cannot be sustained (e.g., due to excessive operating costs). However, the costs management module 215 provides initial modelling, predictive modelling, decision support, and analytics to stakeholders of the transportation network 101 (via the user interface 204).

The cost management module 215 may communicate with the real estate planning module 213 in order to determine land-related costs. For example, the cost management module 215 may communicate with a local land register to determine the taxed value of a parcel. Such value-related information may be utilized by the cost management module 215 in order to determine capital expenditure costs related to acquiring a particular parcel (as potentially determined by the real estate planning module 213). The cost management module 215 may communicate with the demographics module 207 to determine operating costs. For example, if a particular demographic in the suburb 109B would likely never use public transportation, the demographics module 207 may provide such information to the cost management module 215 in order to indicate that ridership may not be high between the suburb 109B and the city 107A. Having a predictive model such as the one described informs stakeholders as to not only the capital expenditure costs but also to the operating costs that will recur over the life of the transportation network 101.

As an example, the route 113B passes through the interior of the city 107A. Deployment of the route 113B may be expensive given the high-density of the city 107A because the cost per square mile (or kilometer) is relatively expensive when compared to nearby regions (e.g., around the suburb 109D). The cost management module 215 may communicate with the real estate planning module 213 in order to determine more precise values for the land (within the city 107A) required for the route 113B. In one aspect, the cost management module 215 may receive analytics from the real estate planning module 213 that relate to the average cost per square foot (or meter).

A human operator may interact with the user interface 204 to obtain modelling information and/or data relating to the transportation network 101 (as configured and analyzed by the operating constraints module 201). For example, assuming an operator is planning to deploy the route 113B as a new route through the city 107A, the operating constraints module 201 may present analytics to the user interface 204 such that a human operator may manipulate and interact with the modelled scenario. For example, the analytics may indicate to a municipality (e.g., the city 107A) that a particular area will generate higher tax revenues with the addition of the portal 115C. Thus, the city 107A may better evaluate the capital expenditure costs against an increase of tax revenue over a period of time.

In addition, the cost management module 215 may be utilized to determine the hyperstructure construction costs related to the deployment and maintenance of a route (e.g., the plurality of routes 113N). In one aspect, the cost management module 215 may be utilized in conjunction with the demographics module 207 such that fares may be set. Varying levels of income may exist across the land area 121A. As such, the cost of fares may be diverse. Therefore, the cost management module 215 may take into consideration such demographic aspects when evaluating both deployment costs (e.g., capital expenditure) as well as operating costs of hyperloop within the transportation network 101.

The predictive planning module 217 is generally configured to determine and predict changes to the transportation network 101. As described herein, the transportation network 101 is a dynamic system where many participants affect one another. For example, the addition of the road 111J creates more use of the hyperloop portal 115E as connected to the suburb 109D. Further, the land use around the suburb 109D may be affected by increased land values, thus affecting future deployments of routes within the transportation network 101.

The predictive planning module 217 may be utilized to determine that land may need to be acquired for expansion within the transportation network 101. For example, the predictive planning module 217 may determine that the land adjoining the land area 121A is inadequate to provide optimized connectivity between the portal 115B and the airport 122A. As such, the predictive planning module 217 may provide information to a human operator via the user interface 204. Such information may include that which is relevant to the acquisition of the land area 121B (e.g., land value, land boundaries, taxed value, ownership, encumbrances, geological characteristics, water supply, suitability for hyperloop, suitability for hyperloop portals, suitability for hyperloop track infrastructure, etc.).

The benefit of providing such predictive information via the user interface 204 is to enable human operators to make informed decisions about the operation and expansion of the transportation network 101. One of skill in the art will appreciate that decision support for human operators is a key benefit of the disclosed solution.

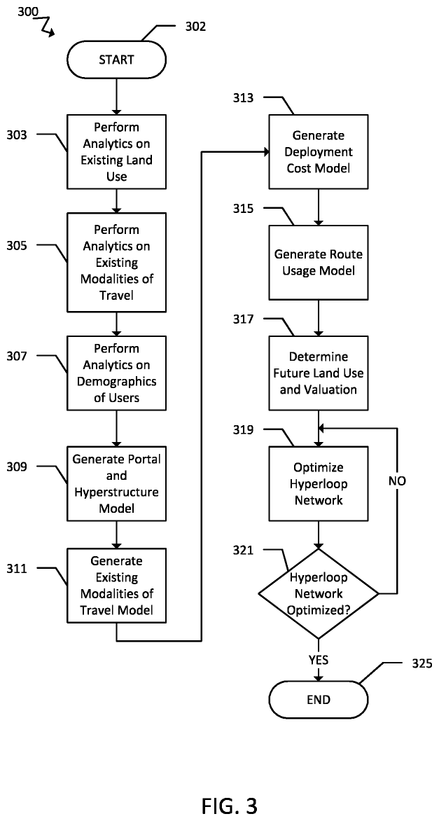

FIG. 3 is a flowchart of a process 301 for performing a hyperloop network deployment. The process 301 begins at the start block 302 and proceeds to the block 303 where the process 301 performs analytics on existing land use. In one aspect, the process 301 may utilize the real estate planning module 213. The real estate planning module 213 may communicate with sources of land use information including: publicly available databases, proprietary databases (e.g., real estate broker databases), websites, tax records, or a combination thereof. Such communication enables the real estate planning module 213 to store and process data that relates generally to land use.

Having land use information enables accurate predictions of the costs and effort associated with expanding the transportation network 101 via additional hyperloop routes (e.g., the route 113E). As such, the process 301 may utilize the functionality of the predictive planning module 217 to determine immediate, near-term factors affecting the existing land use. Stated differently, the real estate planning module 213 may contain more unprocessed, raw data that is subject to subsequent processing by the predictive planning module 217 to generate analytics for human operators at the user interface 204.

The process 301 then proceeds to the block 305. At the block 305, the process 301 may perform analytics on existing modalities of travel. Existing modalities of travel include, but are not limited to: automobile, train, trolley, subway, aircraft, ferry, bus, carpool, ridesharing, etc. The process 301 may utilize the alternative modes of transportation module 211 in order to identify and analyze the presence and nature of alternative modalities in the transportation network 101.

For example, the alternative modes of transportation module 211 may determine that residents of suburb 109B utilize the road 111K to get to the city 107A via automobile and carpool primarily. The use of automobiles may be determined by monitoring equipment disposed near the road 111K. For instance, traffic monitoring cameras using computer vision may detect the presence of vehicles as well as the passengers within said vehicles. By observing the patterns of automobile-based travel, the alternative modes of transportation module 211 may provide the necessary raw and processed data to the predictive planning module 217.

The predictive planning module 217 may be utilized in conjunction with the alternative modes of transportation module 211. In one aspect, the predictive planning module 217 may process, via the processor 202, the data provided by the alternative modes of transportation module 211 such that a human operator may be informed about the existence and nature of non-hyperloop travel within the transportation network 101. Turning back to the example above, if the road 111K is highly congested (even with high carpool ridership), the predictive planning module 217 may provide analytics to a human operator (via the user interface 204). Such analytics may inform the human operator that the route 113A will be likely to have high ridership as commuters shift their mode of transportation from automobile to hyperloop. As stated, the costs related to hyperloop deployment are high and having a confidence in the viability (and profitability) of a route is not just advantageous but necessary in many circumstances. The process 301 then proceeds to the block 307.

At the block 307, the process 301 may perform analytics on demographics of users of the transportation network 101. In one aspect, the process 301 may utilize the demographics module 207. The demographics module 207 may contain varied types of information about users (e.g., commuters) within the transportation network 101; for example, the demographics module 207 may indicate that the inhabitants in suburb 109E prefer to travel via the route 113E because the inhabitants are young professionals who work from home and only travel long distances via airplane. As such, the route 113E may be highly utilized in order to support the behavior of this exemplary demographic. The predictive planning module 217 may be invoked by the process 301 in order to determine, using the processor 202, the nature and extent of the young professional demographic that may frequent the route 113E in order to arrive at the airport 122A.

The predictive planning module 217 may coordinate information from the real estate planning module 213 and the demographics module 207 to determine the relative wealth of a demographic. For example, the land value in the suburb 109A may be higher than that of the suburb 109B. While the demographics module 207 may contain some information relating to the suburbs 109A, 109B, having the land use data (as provided by the real estate planning module 213) enables the predictive planning module 217 to provide more accurate analytics to human operators charged with deploying and managing hyperloop routes.

Additionally, the process 301 may utilize the predictive planning module 217 to determine the effects of deployment of a hyperloop route (or portal) intended for a particular demographic of users (e.g., commuters). As shown in FIG. 1D above, the influence a hyperloop network exerts is dramatic. By introducing a hyperloop route, the demographics may change in a particular location. Providing “green” modes of transportation (like hyperloop) may attract more commuters to a region since hyperloop solves the problem of local fossil emissions without sacrificing user mobility. As people seek more means of reducing fossil fuel consumption, the demographics near a hyperloop portal (e.g., the portal 115C) may become such that automobile ownership decreases. Such a decrease may not only affect hyperloop but other modes as well. For example, the introduction of the route 113E may increase bus ridership between the portal 115E and the suburb 109E, since the users only need “last mile” service, which can easily be provided by existing modes of transportation. The process 301 then proceeds to the block 309.

At the block 309, the process 301 may generate a model of portal and hyperstructure configurations. In one aspect, the process 301 may utilize the functionality of the hyperloop deployment module 209. As disclosed herein, route deployment is complex and based on a number of factors (e.g., demographics, land use, existing modes of transportation, etc.). The hyperloop deployment module 209 may be invoked by the process 301 in order to provide candidate configurations for a human operator to review and manage (via the user interface 204).

For example, the route 113C may be viable or unviable based on the land use around the suburb 109D. In one configuration, the route 113C may follow the road 111G such that land use may leverage existing rights of way. Thus, the land acquisition costs may be lower by following the road 111G. However, the deployment of the route 113C in open land may enable lower construction costs since deployment in open land is generally less complex than deployment near a freeway (such as the road 111G). Therefore, the hyperloop deployment module 209 may provide several candidate configurations of the route 111C such that a human operator (via the user interface 204) may determine a desired candidate for deployment of the hyperloop route (namely, the route 113C).

Further, the process 301 may utilize the functionality of the predictive planning module 217. Since the transportation network 101 is dynamic, the predictive planning module 217 may provide predictive analytics as to how the transportation network 101 may be affected in the future by a candidate hyperloop configuration (as provided by the hyperloop deployment module 209). For example, the deployment of the route 113F may cause the road 111F to become less congested. As such, the predictive planning module 217 may indicate that future maintenance cycles of the road 111F may be reduced since the number of trips per day will decrease over time (thus increasing any maintenance intervals). The process 301 then proceeds to the block 311.

At the block 311, the process 301 may generate a model of existing modalities of transportation. The process 301 may utilize the functionality of the alternative modes of transportation module 211. The model of existing modalities generally represents the existence and nature of existing modalities of travel. For example, the suburb 109B may have two cars per household on average. Further, the inhabitants belong to a demographic that has a small family with two sources of income. Thus, any given household is likely to have up to two commuters who need to travel to the city 107A in order to work. While carpooling may be an option, the model may indicate that few commuters engage in such behavior. The process 301 then proceeds to the block 313.

At the block 313, the process 301 may generate a deployment cost model. The process 301 may utilize the cost management module 215 within the operating constraints module 201. A deployment cost model generally relates to hyperloop deployment costs as demonstrated by: the capital expenditure costs, the operating costs, the maintenance costs, the permitting costs, or a combination thereof. As disclosed, human operators generally require information as to the costs and benefits of deploying a hyperloop route (e.g, the route 111F). The deployment cost model provides analytics to a human operator (via the user interface 204) that contains the current and future costs associated with a hyperloop deployment. The predictive planning module 217 may augment the deployment cost model by adding more data to generate future states of the deployment cost model.

The process 301 then proceeds to the block 315 wherein a route model is generated. In one aspect, the hyperloop deployment module 209 is utilized to plan the plurality of routes 113N within the transportation network 101. A route model may contain the plurality of routes 113N that the human operator (at the user interface 204) may evaluate and adjust based on information shown by the deployment cost model. In one aspect, the predictive planning module 217 may provide real-time information relating to the altering of a given route such that the human operator may fully understand the implications of route deployment (or adjustment). The process 301 then proceeds to the block 317.

At the block 317, the process 301 determines future land use and valuation. In one aspect, the process 301 may utilize the real estate planning module 213 to determine land use and associated valuations. In general, municipalities desire improved land use because the same area of land (after improvement) generates more tax revenue to fund essential services (e.g., fire, police, education, etc.). The process 301 may utilize the functionality of the predictive planning module 217 as part of generating the model of future land use and valuation. The user interface 204 may be accessible by a human operator in order to model and evaluate the effect of hyperloop route deployment on the land value in the future. The process 301 then proceeds to the block 319.

At the block 319, the process 301 may utilize the hyperloop deployment module 209 to optimize the transportation network 101. As described herein, the alternative modes of transportation affect the use of hyperloop networks which further influences land use as well as the alternative modes of transportation themselves. As one of skill in the art may appreciate, the deployment and operation of an optimized transportation network requires analysis of non-linear relationships among disparate variables. Therefore, the process 301 may iteratively update the portal and hyperstructure model generated at the block 309. Given that human operators may update (at the user interface 204) the configuration of the transportation network 101, the process 301 may iterate several times in order to arrive at an optimized configuration of the transportation network 101. The process 301 then proceeds to the decision block 321.

At the decision block 321, the process 301 may determine whether the plurality of routes 113N and the plurality of portals 115N are substantially optimized within the transportation network 101. The portal and hyperstructure model described above may also be optimized as part of this decision block 321. If the transportation network 101 is not optimized, the process 301 proceeds along the NO branch back to the block 319 wherein the hyperloop network (within the transportation network 101) is further optimized by adjusting the plurality of routes 113N and the plurality of portals 115N. Returning to the decision block 321, the process 301 may determine the hyperloop network is substantially optimized and then proceed via the YES branch to the end block 325, at which point the process 301 terminates.

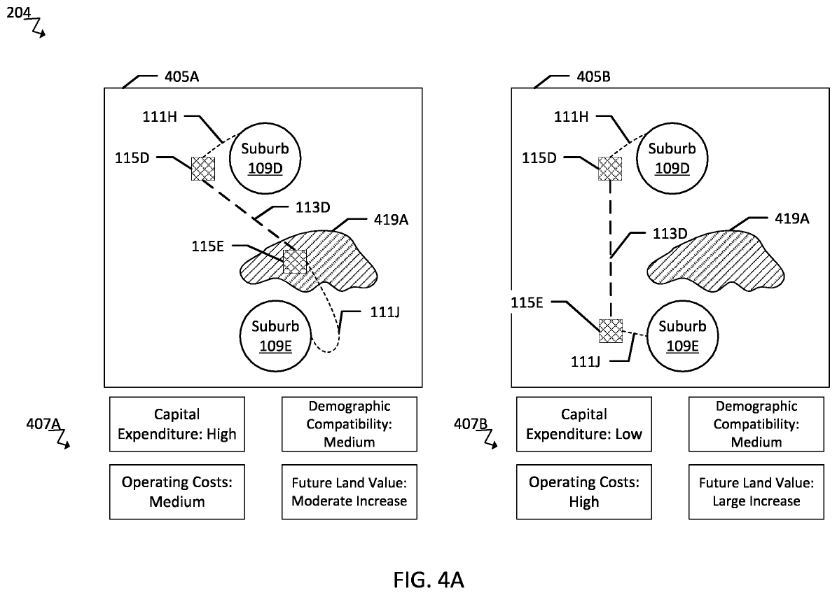

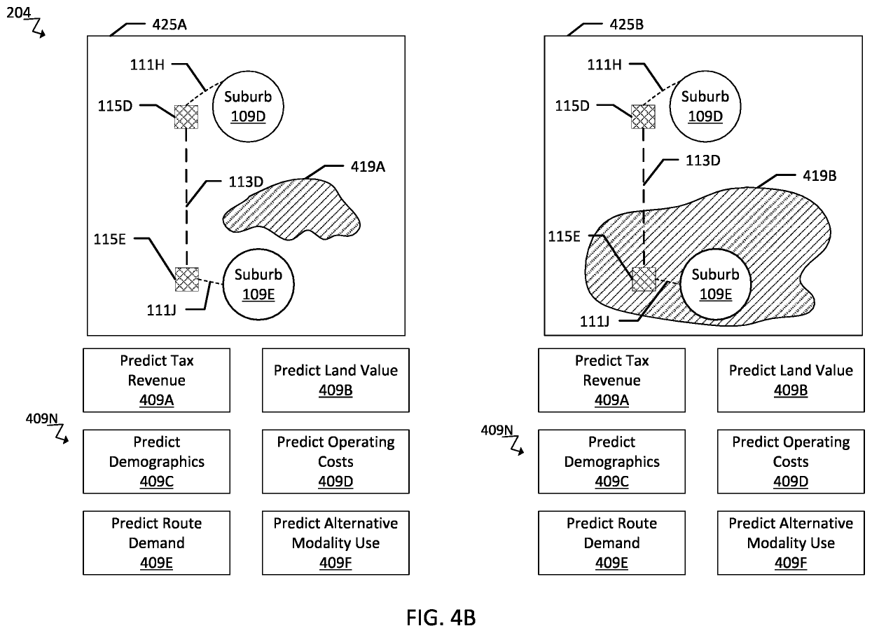

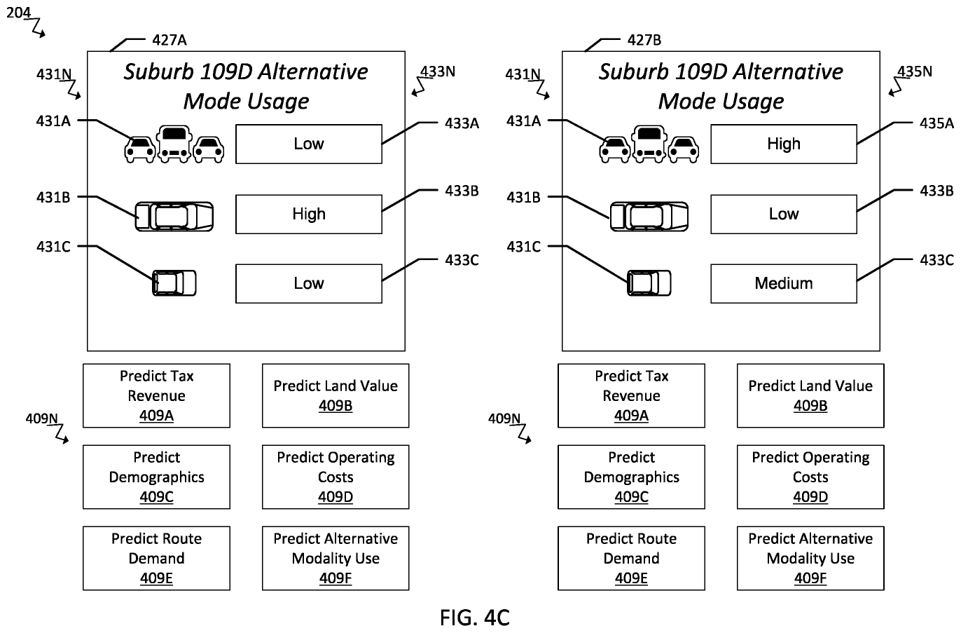

FIG. 4A is block diagram of the user interface 204 configured to deploy the hyperloop portal 115E. The user interface 204 is configured to show a first view 405A and a second view 405B. The view 405A depicts a configuration of a section of the transportation network 101 (as depicted in FIG. 1D). A human operator may interact with the user interface 204 in order to configure the position of the hyperloop portal 115E. A land area 419A is marked in the view 405A to indicate that land valuations are higher relative to nearby land. A plurality of analytics 407A provide various information to a human operator. As shown, the plurality of analytics 407A contain analytics relating to: capital expenditure, demographic compatibility, operating costs, and future land value.

In the configuration depicted in the view 405A, the capital expenditure is high. The position of the portal 115E is within the land area 419A, which has a relatively high land valuation. Operating costs are indicated to be medium (or relatively near the median of a range). The demographic compatibility is indicated as medium. An example demographic that may be compatible with hyperloop are young professionals who live in the city 107A and do not own automobiles. As such, the demographic may be more likely to use a shared mode of transportation (such as hyperloop). The future land value is indicated to moderately increase. Since the land area 419A is already expensive, a further increase is less likely than an area of undeveloped (or undervalued) land.

The second view 405B illustrates the hyperloop portal 115E being shifted to the left and away from the land area 419A. As such, a plurality of analytics 407B are presented to indicate the associated capital expenditure costs, the operating costs, the demographic compatibility, and the future land value increase. The portal 115E is shifted away from the land area 419A, and the capital expenditure costs have decreased to low. However, operating costs are indicated as high. One explanation for the increased operating costs may be due to the remoteness of the portal 115E, thus requiring additional maintenance for an extended length of track. The demographic compatibility is unchanged at medium. Future land value is shown as having a large increase. As stated above, locating the portal 115E in an undeveloped area of land has a much higher likelihood of increasing in value.

FIG. 4B is block diagram of the user interface 204 configured to predict changes in land value. A view 425A depicts a section of the transportation network 101. As shown, the land area 419A has been avoided in order to place the portal 115E in a lower-cost area of land (to the left of the suburb 109E). The land area 419A is of higher value. As disclosed herein, the effect of hyperloop portals may be an increase in land value. Thus, a human operator of the user interface 204 may desire to predict future land use and valuation by use of the process 301 and the operating constraints module 201.

A plurality of buttons 409N are shown on the user interface 204 (below the view 425A) viz. a predict tax review button 409A, a predict land value 409B button, a predict demographics button 409C, a predict operating costs button 409D, a predict route demand button 409E, and a predict alternative modality use button 409F. The plurality of buttons 409N may invoke the functionality of the process 301 and the operating constraints module 201, both of which are described above.

A view 425B depicts the selection of the predict land value button 409B. When selected at the user interface 204, the view 425B shows the expansion of a land area 419B that extends beyond the original boundaries of the land area 419A. The predict land value button 409B may utilize the functionality of the hyperloop deployment module 209, the real estate planning module 213, and the predictive planning module 217.

FIG. 4C is block diagram of the user interface 204 configured to predict alternative mode of travel usage. A view 427A depicts analytics on the user interface 204. A human operator may view the analytics in the view 427A and interact with the view 427A in order to further manage or plan a hyperloop deployment (similar to the ones depicted in FIG. 1A through FIG. 1D). A plurality of indicators 431N are shown viz. a shared travel indicator 431A, a standard automobile indicator 431B, and a compact automobile indicator 431C. The shared travel indicator 431A relates to shared travel which may include bus, carpool, ridesharing, or a combination thereof. The standard automobile indicator 431B relates to automobiles that may seat five or more passengers and generally consume more energy. Lastly, the compact automobile indicator 431C generally relates to compact automobiles that generally seat fewer than five passengers and consume less energy than standard automobiles.

Each of the plurality of indicators 431N correspond to a plurality of analytics 433N, respectively. The plurality of analytics 433A comprise a shared travel analytic 433A, a standard automobile analytic 433B, and a compact automobile analytic 433C. A human operator may view and interact with each of the plurality of analytics 433N via the plurality of buttons 409N. Such analytics provides the human operator with information sufficient to deploy and manage the transportation network 101 because alternative modes of travel will invariably interact with the transportation network 101.

By invoking the functionality of the predict alternative modality use button 409F, a view 427B is shown with an updated plurality of analytics 435A. The predict alternative modality use button 409F may utilize the functionality of the operating constraints module 201, specifically the alternative modes of transportation module 211 and/or the predictive planning module 217. The process 301 may also be utilized by the predict alternative modality use button 409F.

The updated plurality of analytics 435A comprise an updated shared travel analytic 433A, an updated standard automobile analytic 433B, and an updated compact automobile analytic 433C. The difference in the views 427A, 427B generally corresponds to the changes between (1) the transportation network 101 shown in FIG. 1A above and (2) the transportation network 101 shown in FIG. 1D above.

The shared travel analytic 433A indicates an increase in ridership in shared modes of travel, as indicated by the change from low to high. Likewise, the demand and use for standard automobiles has decreased from high to low. Further, the demand and use for compact automobiles has increased from low to medium. Such changes may be due to a number of factors, but one primary factor is the nature of hyperloop replacing other modes of travel. With hyperloop, a passenger only needs to find “last mile” travel between a destination or origin, thus fewer standard automobiles are generally required because passengers only request short-distance trips and may not need the space and power of a larger automobile. Likewise, ridesharing has become more desirable because the distances travelled between a portal (e.g., the portal 115E) and a destination/origin (e.g., the suburb 109E) are generally shorter than travelling by road.

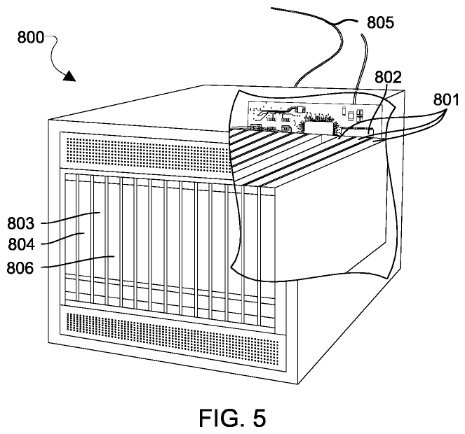

FIG. 5 is a block diagram illustrating a server 800 suitable for use with the various aspects described herein. In one aspect, the server 800 is operable to execute the operating constraints module 201, the user interface 204, and/or the process 301. The server 800 may include one or more processor assemblies 801 (e.g., an x86 processor) coupled to volatile memory 802 (e.g., DRAM) and a large capacity nonvolatile memory 804 (e.g., a magnetic disk drive, a flash disk drive, a solid state drive, etc.). As illustrated in instant figure, processor assemblies 801 may be added to the server 800 by inserting them into the racks of the assembly. The server 800 may also include an optical drive 806 coupled to the processor 801. The server 800 may also include a network access interface 803 (e.g., an ethernet card, WIFI card, etc.) coupled to the processor assemblies 801 for establishing network interface connections with a network 805. The network 805 may be a local area network, the Internet, the public switched telephone network, and/or a cellular data network (e.g., LTE, 5G, etc.).

The foregoing method descriptions and diagrams/figures are provided merely as illustrative examples and are not intended to require or imply that the operations of various aspects must be performed in the order presented. As will be appreciated by one of skill in the art, the order of operations in the aspects described herein may be performed in any order. Words such as “thereafter,” “then,” “next,” etc. are not intended to limit the order of the operations; such words are used to guide the reader through the description of the methods and systems described herein. Further, any reference to claim elements in the singular, for example, using the articles “a,” “an,” or “the” is not to be construed as limiting the element to the singular.

Various illustrative logical blocks, modules, components, circuits, and algorithm operations described in connection with the aspects described herein may be implemented as electronic hardware, computer software, or combinations of both. To clearly illustrate this interchangeability of hardware and software, various illustrative components, blocks, modules, circuits, operations, etc. have been described herein generally in terms of their functionality. Whether such functionality is implemented as hardware or software depends upon the particular application and design constraints imposed on the overall system. One of skill in the art may implement the described functionality in varying ways for each particular application, but such implementation decisions should not be interpreted as causing a departure from the scope of the claims.

The hardware used to implement various illustrative logics, logical blocks, modules, components, circuits, etc. described in connection with the aspects described herein may be implemented or performed with a general purpose processor, a digital signal processor (“DSP”), an application specific integrated circuit (“ASIC”), a field programmable gate array (“FPGA”) or other programmable logic device, discrete gate logic, transistor logic, discrete hardware components, or any combination thereof designed to perform the functions described herein. A general-purpose processor may be a microprocessor, a controller, a microcontroller, a state machine, etc. A processor may also be implemented as a combination of receiver smart objects, e.g., a combination of a DSP and a microprocessor, a plurality of microprocessors, one or more microprocessors in conjunction with a DSP core, or any other such like configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions (or code) on a non-transitory computer-readable storage medium or a non-transitory processor-readable storage medium. The operations of a method or algorithm disclosed herein may be embodied in a processor-executable software module or as processor-executable instructions, both of which may reside on a non-transitory computer-readable or processor-readable storage medium. Non-transitory computer-readable or processor-readable storage media may be any storage media that may be accessed by a computer or a processor (e.g., RAM, flash, etc.). By way of example but not limitation, such non-transitory computer-readable or processor-readable storage media may include RAM, ROM, EEPROM, NAND FLASH, NOR FLASH, M-RAM, P-RAM, R-RAM, CD-ROM, DVD, magnetic disk storage, magnetic storage smart objects, or any other medium that may be used to store program code in the form of instructions or data structures and that may be accessed by a computer. Disk as used herein may refer to magnetic or non-magnetic storage operable to store instructions or code. Disc refers to any optical disc operable to store instructions or code. Combinations of any of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed aspects is provided to enable any person skilled in the art to make, implement, or use the claims. Various modifications to these aspects will be readily apparent to those skilled in the art, and the generic principles defined herein may be applied to other aspects without departing from the scope of the claims. Thus, the present disclosure is not intended to be limited to the aspects illustrated herein but is to be accorded the widest scope consistent with the claims disclosed herein.

1. A method for deploying a transportation network having a hyperloop network, the method comprising:
performing, at a processor, analytics on existing land use within a land area to form an existing land use model;
generating, at the processor, a portal infrastructure model, the portal infrastructure model relating to a real-world layout of a plurality of hyperloop portals;
generating, at the processor, a hyperstructure model, the hyperstructure model relating to a real-world layout of a plurality of routes, the plurality of routes being configured for hyperloop transportation between the plurality of portals;
generating, at the processor, a route usage model, the route usage model being based on the hyperstructure model and the portal infrastructure model;
generating, at the processor, a deployment cost model, the deployment cost model having a capital expenditure component and an operating costs component, the capital expenditure component relating to the portal infrastructure model and the hyperstructure model, the operating costs component relating to the route usage model;
generating, at the processor, a first plurality of analytics, the first plurality of analytics being based on the deployment cost model; and
presenting, at a user interface, the first plurality of analytics.

2. The method of claim 1, the method further comprising:
generating, at the processor, a future land use model, the future land use model being based on the existing land use model;
generating, at the processor, a future deployment cost model, the future deployment cost model being based on the deployment cost model;
generating, at the processor, a second plurality of analytics, the second plurality of analytics being based on the future deployment cost model; and
presenting, at the user interface, the second plurality of analytics.

3. The method of claim 1, the method further comprising:
generating, at the processor, an existing modalities of travel model, the existing modalities of travel model being based on non-hyperloop modalities of travel;
generating, at the processor, a third plurality of analytics, the third plurality of analytics being based on the existing modalities of travel model; and
presenting, at the user interface, the third plurality of analytics.

4. The method of claim 1, the method further comprising:
generating, at the processor, a demographics model, the demographics model being based on a demographic;
generating, at the processor, a fourth plurality of analytics, the fourth plurality of analytics being based on the demographics model; and
presenting, at the user interface, the fourth plurality of analytics.

5. The method of claim 1, the method further comprising:
combining, at the processor, the existing land use model, the portal infrastructure model, the hyperstructure model, the route usage model, the deployment cost model to form a transportation network model, the transportation network model being related to the transportation network; and
optimizing, at the processor, the transportation network model to form an optimized transportation network model.

6. A method for presenting a transportation network on a user interface, the method comprising:
generating, at a processor, a transportation network model, the transportation network model being a logical representation of the transportation network, the transportation network having a hyperloop component;
generating, at the processor, a land use model, the land use model being based on a real-world land area and the transportation network model;
generating, at the processor, a first plurality of analytics, the first plurality of analytics being based on the land use model; and
presenting, at the user interface, the first plurality of analytics.

7. The method of claim 6, the method further comprising:
generating, at the processor, a future transportation network model, the future transportation network model being based on the transportation network model;
generating, at the processor, a prediction of a future land use model, the prediction being based on the land use model and the future transportation network model; and
generating, at the processor, a second plurality of analytics, the second plurality of analytics being based on the future land use model; and
presenting, at the user interface, the second plurality of analytics.

8. The method of claim 6, the method further comprising:
receiving, at the user interface, input modifying the transportation network model;
generating, at the processor, a modified transportation network model based on the received input;
generating, at the processor, a third plurality of analytics, the third plurality of analytics being based on the modified transportation network model; and
presenting, at the user interface, the third plurality of analytics.

9. The method of claim 6, the method further comprising:
generating, at the processor, an existing modalities of travel model based on modes of non-hyperloop transportation;
generating, at the processor, a fourth plurality of analytics, the fourth plurality of analytics being based on the existing modalities of travel model; and
presenting, at the user interface, the fourth plurality of analytics.

10. A computing device configured to deploy a transportation network having a hyperloop network, the computing device comprising:
a memory;
a user interface;
a processor, the processor configured to:
perform analytics on existing land use within a land area to form an existing land use model;
generate a portal infrastructure model, the portal infrastructure model relating to a real-world layout of a plurality of hyperloop portals;
generate a hyperstructure model, the hyperstructure model relating to a real-world layout of a plurality of routes, the plurality of routes being configured for hyperloop transportation between the plurality of portals;
generate a route usage model, the route usage model being based on the hyperstructure model and the portal infrastructure model;
generate a deployment cost model, the deployment cost model having a capital expenditure component and an operating costs component, the capital expenditure component relating to the portal infrastructure model and the hyperstructure model, the operating costs component relating to the route usage model;
generate a first plurality of analytics, the first plurality of analytics being based on the deployment cost model and being stored in the memory; and
present, at the user interface, the first plurality of analytics.

11. The computing device of claim 10, the processor being further configured to:
generate a future land use model, the future land use model being based on the existing land use model;
generate a future deployment cost model, the future deployment cost model being based on the deployment cost model;
generate a second plurality of analytics, the second plurality of analytics being based on the future deployment cost model and being stored in the memory; and
present, at the user interface, the second plurality of analytics.

12. The computing device of claim 10, the processor being further configured to:
generate an existing modalities of travel model, the existing modalities of travel model being based on non-hyperloop modalities of travel;
generate a third plurality of analytics, the third plurality of analytics being based on the existing modalities of travel model and being stored in the memory; and
present, at the user interface, the third plurality of analytics.

13. The computing device of claim 10, the processor being further configured to:
generate a demographics model, the demographics model being based on a demographic;
generate a fourth plurality of analytics, the fourth plurality of analytics being based on the demographics model and being stored in the memory; and
present, at the user interface, the fourth plurality of analytics.

14. The computing device of claim 10, the processor being further configured to:
combine the existing land use model, the portal infrastructure model, the hyperstructure model, the route usage model, the deployment cost model to form a transportation network model, the transportation network model being related to the transportation network; and
optimize the transportation network model to form an optimized transportation network model, the optimized transportation network model being stored in the memory.

15. The computing device of claim 10, wherein the computing device is a server.

16. A computing device configured to present a transportation network on a user interface, the computing device comprising:
a memory;
the user interface;
a processor, the processor being configured to:
generate a transportation network model, the transportation network model being a logical representation of the transportation network, the transportation network having a hyperloop component;
generate a land use model, the land use model being based on a real-world land area and the transportation network model;
generate a first plurality of analytics, the first plurality of analytics being based on the land use model and being stored in the memory; and
present, at the user interface, the first plurality of analytics.

17. The computing device of claim 16, the processor being further configured to:
generate a future transportation network model, the future transportation network model being based on the transportation network model;
generate a prediction of a future land use model, the prediction being based on the land use model and the future transportation network model; and
generate a second plurality of analytics, the second plurality of analytics being based on the future land use model and being stored in the memory; and
present, at the user interface, the second plurality of analytics.

18. The computing device of claim 16, the processor being further configured to:
receive, at the user interface, input modifying the transportation network model;
generate a modified transportation network model based on the received input;
generate a third plurality of analytics, the third plurality of analytics being based on the modified transportation network model and being stored in the memory; and
present, at the user interface, the third plurality of analytics.

19. The computing device of claim 16, the processor being further configured to:
generate an existing modalities of travel model based on modes of non-hyperloop transportation;
generate a fourth plurality of analytics, the fourth plurality of analytics being based on the existing modalities of travel model and being stored in the memory; and
present, at the user interface, the fourth plurality of analytics.

20. The computing device of claim 16, wherein the computing device is a server.
